(19) United States
(12) Patent Application Publication
(10) Pub. No.: US 2024/0233482 A9
(43) Pub. Date: Jul. 11, 2024

(54) Methods and Systems For A CASINO and/or Sports betting GAMING Product

(71) Applicant: WagerWheel LLC, Park Ridge, IL (US)

(72) Inventor: Nicholas R. Corlett, Park Ridge, IL (US)

(21) Appl. No.: 18/381,526

(22) Filed: Oct. 18, 2023

Related U.S. Application Data
(60) Provisional application No. 63/380,363, filed on Oct. 20, 2022.

(51) Int. Cl. G07F 17/32

(52) U.S. Cl. CPC G07F 17/323; G07F 17/3209; G07F 17/3211; G07F 17/3262; G07F 17/3288

(57) ABSTRACT

The present application is directed to a casino/sports-betting gaming system with methods and systems for a casino game/add-on (WagerWheel) used for sports betting. WagerWheel is a casino game that allows a bettor the chance to increase their odds on sports bets. WagerWheel will add volatility to sports betting by allowing guests to spin a wheel(s). A bettor will simply choose a desired bet, enter a bet amount, and spin the wheel(s) and depending on the outcome of the spin, the wheel results will either add or subtract to the selected bet. By charging a small fee to spin the wheel(s), operators will not forgo their house edge to boost odds.

### CROSS-REFERENCE TO RELATED APPLICATIONS

This application claims priority to U.S. Provisional Application No. 63/380,363, filed Oct. 20, 2022, all of which is herein incorporated by reference in its entirety.

### FIELD

Aspects of the disclosure generally relate to methods and computer systems, including one or more computers particularly configured and/or executing computer software. More specifically, aspects of this disclosure relate to a casino/sports-betting gaming system with methods and systems for a casino game/add-on used for sports betting. Technical field: Sports betting, casino games, casino promotions, casino bonuses, odds boosters.

### BACKGROUND

Sports betting is a very crowded market. Sportsbook operators are constantly trying to differentiate themselves. Sports betting is a never-ending cycle of spending money in order for sportsbook operators to continue making their products better. This perennial issue damages bottom line profits and costs sportsbook operators a lot of money to acquire, retain, and reactivate new and existing users. Traditional odds boosters are used as promotions, and customer acquisition, Odds boosters are a a promotion that operators use which boosts the odds in favor of the bettor. Simply put odds boosters are regular bets offered at enticing odds. The sportsbook operator will give up some or most of the for these boosted wagers, sometimes forcing the operator to forgo their house edge. “Vig,” or vigorish, is the cut or amount charged by a sportsbook for taking a bet, also known as juice in slang terms. The sportsbook operator only collects the vig if the bettor loses the wager.

Odds boost promotions are oftentimes limited to specific games, sports, or bet types, which gives bettors a limited number of options. Sportsbook operators use odds boosters as a tool to highlight specific games that entices the user with boosted odds on an event they may or may not be interested in. Traditional odds boosters tend to be used on straight bets. Volatility in sports betting relies on two variables: stake and odds. With straight bets, in order for a bettor to win a significant amount of money, a bettor can either risk a lot of money on a favorite (higher stake) or bet on an underdog (higher odds). Therefore, odds boosters are successful ways of attracting new and existing users. With traditional odds boosters, sportsbook operators may forgo house edge to attract users. Sportsbook operators may even be taken advantage of due to the price disparities of highly boosted odds. Since sportsbook operators may give up some vig, these promotions cannot be used often as they are not always profitable for the sportsbook operator. The solution? Allowing users to spin a wheel(s) for a chance to boost their odds using a novel casino/sports-betting gaming system. The wheel included with the casino/sports-betting gaming system may not be proportional, so the casino/sports-betting gaming system may allow sportsbook operators to offer users the chance at boosted odds for any bet type and any event without giving up their house edge.

### SUMMARY

The following presents a simplified summary of the disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

Aspects of this disclosure pertain to a technology-enabled casino/sports-betting gaming system with methods and systems for a casino game/add-on used for sports betting.

For example, in one embodiment, a gaming device may comprise: a display device; a touch screen input; a processor connected to the display device and the touch screen input; and a memory coupled to the processor, the memory comprising machine-readable instructions. The machine-readable instructions, when executed by the processor, may cause the processor to: receive, from a data storage device, wager data corresponding to a plurality of events, betting lines, and wagers; generate a graphical user interface (GUI) on the display device that receives an input that corresponds to a wager, wherein the input comprises a first wager input and a second wager input corresponding to the wager data; receive, via the GUI, the first wager input that selects a wager team, a wager line, and a wager odds from the wager data; after receiving the first wager input, receive, via the GUI, the second wager input that selects a wagering amount; after receiving the second wager input, receive, via the GUI, an odds booster input that corresponds to an odds booster game for the wager team, the wager line, the wager odds, and the wagering amount, wherein the odds booster game changes the wager line and the wager odds, wherein the odds booster game includes a machine learning algorithm executing within the processor that includes one or more of a line adjustment graphic and an odds adjustment graphic; generate the line adjustment graphic on the GUI, via the machine learning algorithm executing within the processor; calculate and adjust, via the machine learning algorithm executing within the processor, an adjusted wager line using the line adjustment graphic; generate the odds adjustment graphic on the GUI, via the machine learning algorithm executing within the processor; calculate and adjust, via the machine learning algorithm executing within the processor, an adjusted wager odds using the odds adjustment graphic; display, via the GUI, final wager data that includes the wager team, the adjusted wager line, the adjusted wager odds, and the wagering amount; and send, via a communication interface and to the data storage device, the final wager data corresponding to the wager team, the adjusted wager line, the adjusted wager odds, and the wagering amount.

Additionally, the line adjustment graphic may include a line differential wheel that includes a plurality of line adjustments as calculated by the machine learning algorithm executing within the processor. The plurality of line adjustments may include one or more positive line adjustments and one or more negative line adjustments. The odds adjustment graphic may include an odds wheel that includes a plurality of odds adjustments as calculated by the machine learning algorithm executing within the processor. The plurality of odds adjustments may include one or more positive odds adjustments and one or more negative odds adjustments. The wager data may comprise a home/away indication and event time/date information. The display device, the touch screen input, and the processor may be included within a mobile device. The gaming device may further include a gaming terminal with a housing that encloses the display device, the touch screen input, and the processor.

In another embodiment, a computer-implemented method for a casino/sports-betting gaming system with an odds booster game may comprise one or more of the following steps: receiving, from a data storage device, wager data corresponding to a plurality of events, betting lines, and wagers; generating a graphical user interface (GUI) on a display device that receives an input that corresponds to a wager, wherein the input comprises a first wager input and a second wager input corresponding to the wager data; receiving, via the GUI, the first wager input that selects a wager team, a wager line, and a wager odds from the wager data; after receiving the first wager input, receiving, via the GUI, the second wager input that selects a wagering amount; after receiving the second wager input, receiving, via the GUI, an odds booster input that corresponds to an odds booster game for the wager team, the wager line, the wager odds, and the wagering amount, wherein the odds booster game changes the wager line and the wager odds, wherein the odds booster game includes a machine learning algorithm executing within a processor that includes one or more of a line adjustment graphic and an odds adjustment graphic; generating the line adjustment graphic on the GUI, via the machine learning algorithm executing within the processor; calculating and adjusting, via the machine learning algorithm executing within the processor, an adjusted wager line using the line adjustment graphic; generating the odds adjustment graphic on the GUI, via the machine learning algorithm executing within the processor; calculating and adjusting, via the machine learning algorithm executing within the processor, an adjusted wager odds using the odds adjustment graphic; displaying, via the GUI, final wager data that includes the wager team, the adjusted wager line, the adjusted wager odds, and the wagering amount; and sending, via a communication interface and to the data storage device, the final wager data corresponding to the wager team, the adjusted wager line, the adjusted wager odds, and the wagering amount.

In yet another embodiment, a system for an odds booster game may comprise a processor and a memory coupled to the processor, the memory comprising machine-readable instructions. The machine-readable instructions, when executed by the processor, may cause the processor to: receive, from a data storage device, wager data corresponding to a plurality of events, betting lines, and wagers; generate a graphical user interface (GUI) on a display device that receives an input that corresponds to a wager, wherein the input comprises a first wager input and a second wager input corresponding to the wager data; receive, via the GUI, the first wager input that selects a wager team, a wager line, and a wager odds from the wager data; after receiving the first wager input, receive, via the GUI, the second wager input that selects a wagering amount; after receiving the second wager input, receive, via the GUI, an odds booster input that corresponds to an odds booster game for the wager team, the wager line, the wager odds, and the wagering amount, wherein the odds booster game changes the wager line and the wager odds, wherein the odds booster game includes a machine learning algorithm executing within the processor that includes one or more of a line adjustment graphic and an odds adjustment graphic; generate, calculate, and adjust, via the machine learning algorithm executing within the processor, an adjusted wager line using a line adjustment graphic; generate, calculate, and adjust, via the machine learning algorithm executing within the processor, an adjusted wager odds using an odds adjustment graphic; display, via the GUI, final wager data that includes the wager team, the adjusted wager line, the adjusted wager odds, and the wagering amount; and send, via a communication interface and to the data storage device, the final wager data corresponding to the wager team, the adjusted wager line, the adjusted wager odds, and the wagering amount.

These as well as other novel advantages, details, embodiments, features and objects of the present disclosure will be apparent to those skilled in the art from following the detailed description of the disclosure, the attached claims and accompanying drawings, listed herein, which are useful in explaining the disclosure.

### BRIEF DESCRIPTION OF THE DRAWINGS

A more complete understanding of the present disclosure and the advantages thereof may be acquired by referring to the following description in consideration of the accompanying drawings, in which like reference numbers indicate like features, and wherein:

FIG. 1 shows an example betting line that may be used with the casino/sports-betting gaming system and WagerWheel in accordance with aspects of this invention.

FIG. 2 illustrates an exemplary embodiment of the casino/sports-betting gaming system and WagerWheel in accordance with aspects of this invention.

FIG. 3 illustrates another exemplary embodiment of the casino/sports-betting gaming system and WagerWheel in accordance with aspects of this invention.

FIG. 4 illustrates another exemplary embodiment of the casino/sports-betting gaming system and WagerWheel in accordance with aspects of this invention.

FIG. 5 illustrates another exemplary embodiment of the casino/sports-betting gaming system and WagerWheel in accordance with aspects of this invention.

FIG. 6 illustrates yet another exemplary embodiment of the casino/sports-betting gaming system and WagerWheel in accordance with aspects of this invention.

### DETAILED DESCRIPTION

In the following description of the various examples, reference is made to the accompanying drawings, which form a part hereof, and in which is shown by way of illustration various examples in which aspects may be practiced. References to “embodiment,” “example,” and the like indicate that the embodiment(s) or example(s) of the disclosure so described may include particular features, structures, or characteristics, but not every embodiment or example necessarily includes the particular features, structures, or characteristics. Further, it is contemplated that certain embodiments or examples may have some, all, or none of the features described for other examples. And it is to be understood that other embodiments and examples may be utilized and structural and functional modifications may be made without departing from the scope of the present disclosure.

The present application is directed to a casino/sports-betting gaming system (WagerWheel) with methods and systems for a casino game/add-on used for sports betting. The casino/sports-betting gaming system may include a casino game/add-on that is used for sports betting. This game/add-on will allow the user the chance to increase the odds of sports bets. A user will pay a small fee to spin an odds booster wheel(s). By using positive and negative numbers, each wheel may affect the outcome of the original betting line. Odds can be increased or decreased relative to the original betting line (selected by the user) by either adding or subtracting the wheel spin results. There can be multiple wheels. One wheel will change the betting line which may include: point spread, game totals (i.e. over/unders), team totals, player props, or any other bet type that is offered. The other wheel will change the odds or moneylines. Using a wheel(s) as an odds booster will allow the guest to have the chance at boosted odds for any game, any sport and any bet type.

Other items other than a wheel may be used to “spin” or change the odds booster for the casino game/add-on for the casino/sports-betting gaming system without departing from this invention. For example, instead of a spinning wheel, a user may swipe or initiate the moving of a horizontal or vertical changing pane, such as by using a lever or button or other initiation object. In another example, instead of a spinning wheel, a user may initiate the selection of a small box within in a larger box or rectangle full of various odds boosting objects using a button or selection object. Other types of selections and changes of the odds booster may be utilized instead of the wheel without departing from this invention.

Mode of Operation:

First, a user will go through the traditional process of placing a bet on a sportsbook. The user will: 1) Navigate to desired game and bet type; 2) Click on the desired bet; 3) Selected bet will pop up into bet slip; 4) Enter bet $ amount. Instead of placing that bet like the user traditionally would, WagerWheel will provide a game where guests can pay a fee to spin the wheel(s) to try and increase their odds.

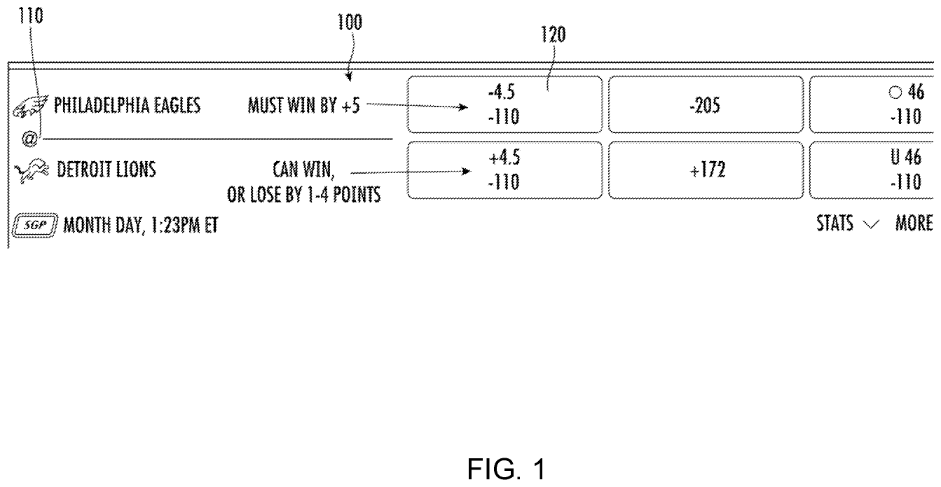

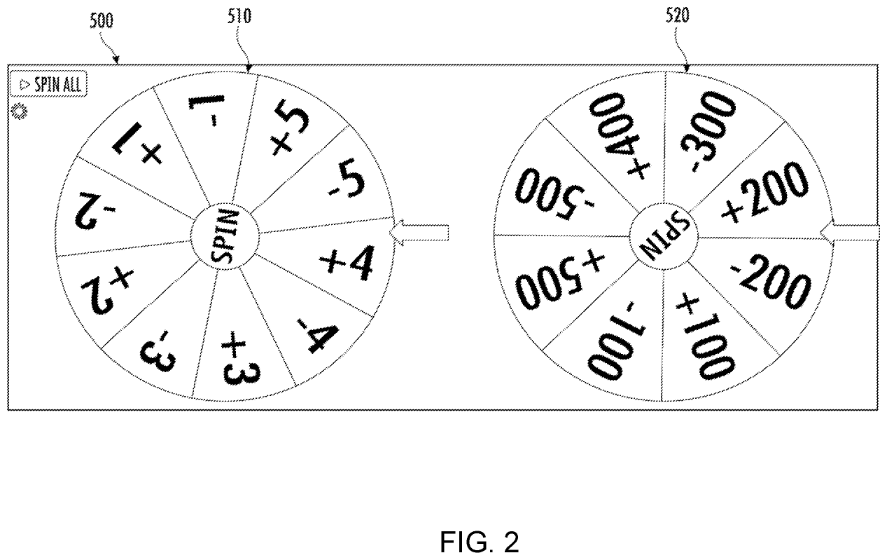

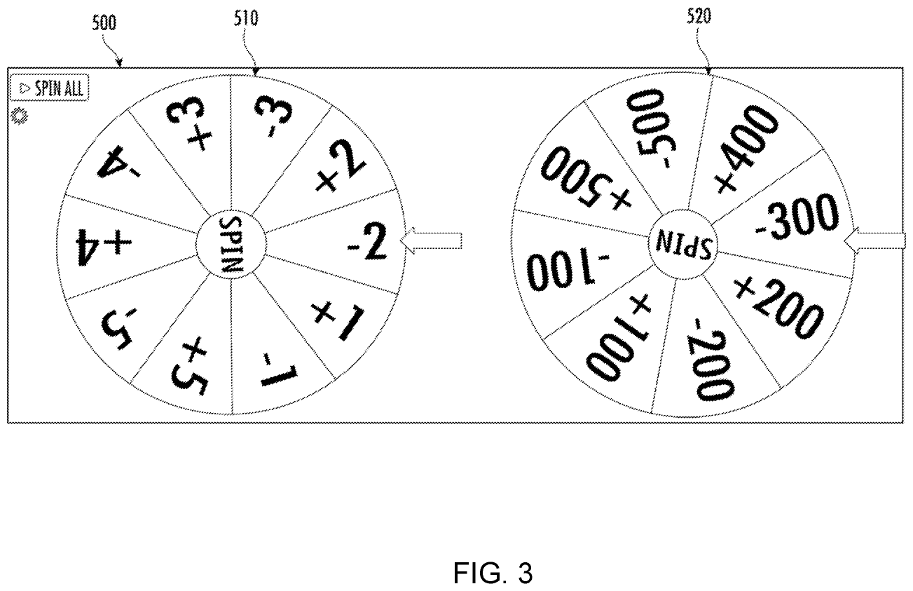

See example betting line 100 in FIG. 1. As illustrated in FIG. 1, the user's desired bet is the point spread of the Eagles/Lions game 110. The user wants the Eagles −4.5 at −110 odds 120. The user would: 1) select Eagles −4.5 −110 (120); 2) enter bet amount; and 3) pay a small fee to then spin the WagerWheel(s). Example WagerWheels 200, 300 are illustrated in FIGS. 2 and 3. FIG. 2 illustrates a spin of the wheel(s) 200, 210, 220 that can result in boosted odds which can be favorable for the bettor. FIG. 3 illustrates a spin of the wheel(s) 300, 310, 320 that can result in boosted odds which can be favorable for the sportsbook operator.

As illustrated in FIG. 2, the WagerWheel 200 may include two wheels 210, 220. The first wheel 210 would add/subtract to the original −4.5 line that the user selected. First, the user may spin the first wheel 210 and the user got +4. This spin on the first wheel 210 would add 4 points to the original line selected (−4.5). The original line now moves from the Eagles winning by 4.5 points, to the Eagles winning by half a point. Additionally, the odds change the user gets during this spin are boosted relative to the original line. The second wheel 220 would affect and/or change the odds of the bet that the user selected. For example, whatever the spin lands on with the second wheel 220, will be user's new odds for their original bet. Next, the user may spin the second wheel 220 and the user got +200. These new odds are boosted odds which may be relative to the original −110 odds. The user will now get paid out 2−1 if the bet hits, instead of getting paid 10/11 odds (−110).

As illustrated in FIG. 3, the WagerWheel 300 may include two wheels 310, 320. The first wheel 310 would add/subtract to the original −4.5 line that the user selected. First, the user may spin the first wheel 310 and the user got −2. This spin on the first wheel 310 would subtract 2 points to the original line selected (−4.5). The original line now moves from the Eagles winning by 4.5 points, to the Eagles winning by 6.5 points. Additionally, the odds change the user gets during this spin are boosted relative to the original line. The second wheel 320 would affect and/or change the odds of the bet that the user selected. For example, whatever the spin lands on with the second wheel 320, will be user's new odds for their original bet. Next, the user may spin the second wheel 320 and the user got −300. These new odds are odds which may be relative to the original −110 odds. The user will now get paid out 1/3 (−300) if the bet hits instead of getting paid 10/11 odds (−110).

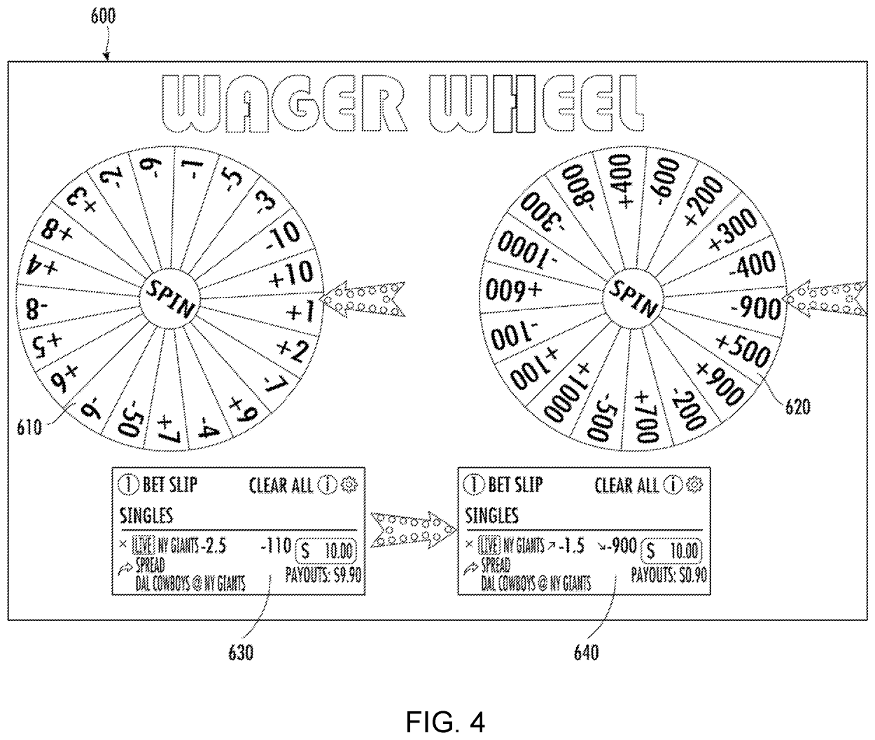

FIG. 4 illustrates another exemplary embodiment of the casino/sports-betting gaming system and WagerWheel 400, which represents an illustration of what the game may look like, two wager wheels 410, 420, the wheel spin results 430, payout adjustments and betting line adjustments 440 (relative to the original selected bet type and listed odds).

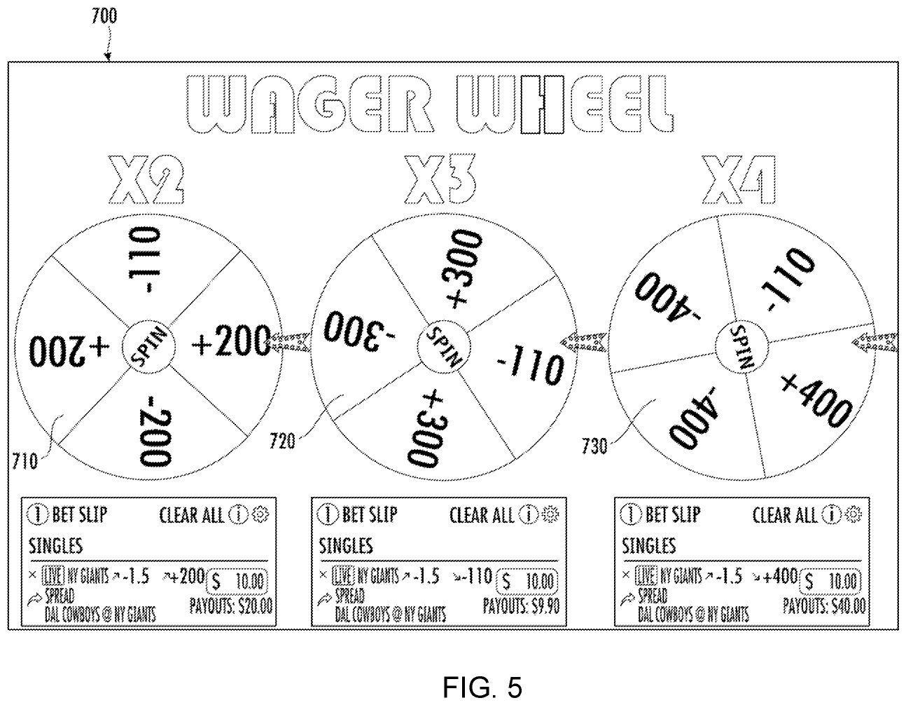

FIG. 5 illustrates another exemplary embodiment of the casino/sports-betting gaming system and WagerWheel 500, which represents how an odds booster can be used without forgoing the house edge, being taken advantage of, and still offer users a chance at boosted odds.

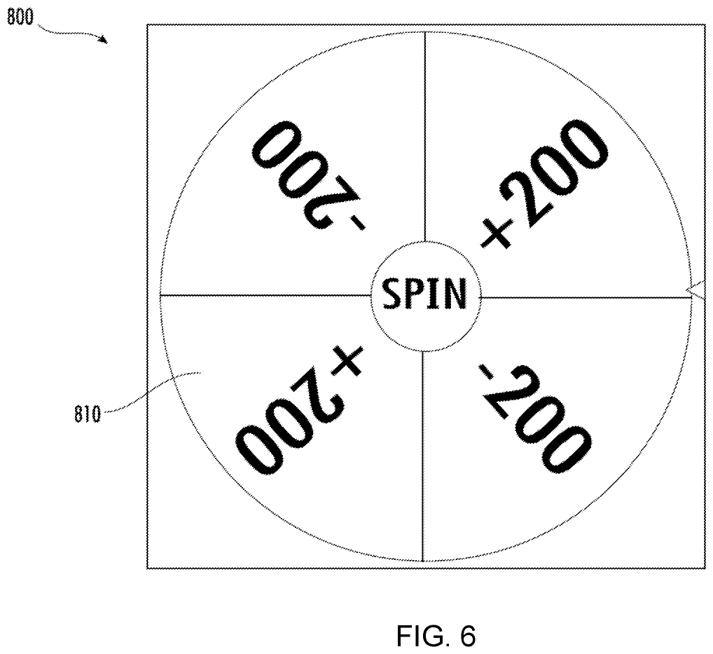

FIG. 6 illustrates yet another exemplary embodiment of the casino/sports-betting gaming system and WagerWheel 600.

Sportsbook Operator/Casino Math and Mechanics:

By using this WagerWheel setup in FIGS. 5 and 6 or other exemplary embodiments, the wheel setup to allow users to increase potential payouts, which increases the odds/edge for the sportsbook operator.

For example, with traditional odds; If the Bears are playing the Packers and the money line is −110 for both teams, the odds/edge for the sportsbook operator would be 4.55%

When using WagerWheel odds and the WagerWheel 500 shown in FIG. 6, there is a 50% chance the wheel lands on −200 and a 50% chance the wheel lands on +200. If the wheel lands on −200, the odds/edge for the sportsbook operator would be 16%. If the wheel lands on +200, the odds/edge for the sportsbook operator would be −16.67%. By charging the user, for example, a 20% fee to spin the wheel (20% of the bet amount), this 20% fee would offset the potential loss of a +200 spin, while still increasing the overall odds/edge for the sportsbook operator.

As stated earlier, volatility in sports betting relies on two variables: stake and odds. For the bettor to win a good amount of money on a straight bet, the user can either bet a large amount on a favorite (higher stake), bet a smaller amount on an underdog (higher odds), or sometimes attempt to find an odds booster promotion. Also stated earlier, there are many problems with traditional odds booster promotions, including limited offerings for the bettor and taking away some of the vig for the sportsbook operator.

With the WagerWheel 500 shown in FIG. 5, the user will pay a small fee to spin an odds booster wheel(s) 510, 520, 530. The fee will vary depending on the potential payout and the wheel that the user selects to spin. The higher the potential payout, the higher the fee. For example, if the user wants to spin the first wheel 510, the ×2 Wheel, the fee may be 20% of amount wagered. If the user wants to spin the second wheel 520, the ×3 Wheel, the fee may be 30% of amount wagered. If the user wants to spin the third wheel 530, the ×4 Wheel, the fee may be 40% of amount wagered. Etc.

It should be understood, that any of the listed odds boosters values and numbers as cited in examples for the various WagerWheel embodiments may be changed and varied without departing from this invention.

The casino game/add-on (WagerWheel) used for sports betting game and executing on a casino/sports-betting gaming system can be used in mobile or web-based platforms, and potentially built into physical machines. The physical machines would work the same, giving land-based sportsbook operators the same benefits that WagerWheel would provide to online sportsbook operators. The casino game/add-on (WagerWheel) used for sports betting game and executing on a casino/sports-betting gaming system is a multi-tier product which will resolve a lot of issues that sportsbook operators face when dealing with: 1) acquisition-new users; 2) bonuses and promotions for both new and existing users; 3) retention of both new and existing users (not losing wallet to other sportsbook operators); and 4) reactivation of existing users.

WagerWheel will offer guests the chance at odds the users won't be able to find at any other sportsbook.

Since this casino game/add-on (WagerWheel) used for sports betting game and executing on a casino/sports-betting gaming system can be used on events before they occur, WagerWheel will make money off spins before any events are resolved.

The casino game/add-on (WagerWheel) used for sports betting game and executing on a casino/sports-betting gaming system can be used for free-spin promotions for new and existing users.

Overall, WagerWheel will benefit both the user/guest by offering enticing odds all the time that can be used on any event, for any bet type.

Additionally, WagerWheel will benefit the sportsbook operator by: 1) low-cost promotions; 2) acquiring guests; 3) retaining guests; 4) reactivating guests; and adding volatility to sports betting.

Aspects of the disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

Additionally, the casino game/add-on (WagerWheel) used for sports betting may include a machine learning algorithm that may execute or operate on casino/sports-betting gaming system. The casino/sports-betting gaming system may utilize a machine learning algorithm for learning trends and improving analyzing, calculating, identifying, weighting betting and odds booster information and values from historical determinations. The machine learning algorithm may utilize one or more of a variety of machine learning architectures known and used in the art. These architectures can include, but are not limited to, neural networks (NN), recurrent neural networks (RNN), convolutional neural networks (CNN), transformers, and/or probabilistic neural networks (PNN), linear regression, random forest, decision trees, k-nearest neighbors, support vector machines (SVM), logistical regression, k-means clustering, association rules. RNNs can further include (but are not limited to) fully recurrent networks, Hopfield networks, Boltzmann machines, self-organizing maps, learning vector quantization, simple recurrent networks, echo state networks, long short-term memory networks, bi-directional RNNs, hierarchical RNNs, stochastic neural networks, and/or genetic scale RNNs. In a number of embodiments, a combination of machine learning architectures can be utilized, more specific machine learning architectures when available, and general machine learning architectures at other times can be used. Additionally, the machine learning algorithm may use semi-supervised learning and/or reinforcement learning.

In the foregoing specification, the present disclosure has been described with reference to specific exemplary embodiments thereof. Although the disclosure has been described in terms of a preferred embodiment, those skilled in the art will recognize that various modifications, embodiments or variations of the disclosure can be practiced within the spirit and scope of the disclosure as set forth in the appended claims. The specification and drawings are, therefore, to be regarded in an illustrated rather than restrictive sense. Accordingly, it is not intended that the disclosure be limited except as may be necessary in view of the appended claims.

We claim:

1. A gaming device comprising:
a display device;
a touch screen input;
a processor connected to the display device and the touch screen input; and
a memory coupled to the processor, the memory comprising machine-readable instructions that, when executed by the processor, cause the processor to:
receive, from a data storage device, wager data corresponding to a plurality of events, betting lines, and wagers;
generate a graphical user interface (GUI) on the display device that receives an input that corresponds to a wager, wherein the input comprises a first wager input and a second wager input corresponding to the wager data;
receive, via the GUI, the first wager input that selects a wager team, a wager line, and a wager odds from the wager data;
after receiving the first wager input, receive, via the GUI, the second wager input that selects a wagering amount;
after receiving the second wager input, receive, via the GUI, an odds booster input that corresponds to an odds booster game for the wager team, the wager line, the wager odds, and the wagering amount, wherein the odds booster game changes the wager line and the wager odds, wherein the odds booster game includes a machine learning algorithm executing within the processor that includes one or more of a line adjustment graphic and an odds adjustment graphic;
generate the line adjustment graphic on the GUI, via the machine learning algorithm executing within the processor;
calculate and adjust, via the machine learning algorithm executing within the processor, an adjusted wager line using the line adjustment graphic;
generate the odds adjustment graphic on the GUI, via the machine learning algorithm executing within the processor;
calculate and adjust, via the machine learning algorithm executing within the processor, an adjusted wager odds using the odds adjustment graphic;
display, via the GUI, final wager data that includes the wager team, the adjusted wager line, the adjusted wager odds, and the wagering amount; and
send, via a communication interface and to the data storage device, the final wager data corresponding to the wager team, the adjusted wager line, the adjusted wager odds, and the wagering amount.

2. The gaming device of claim 1, wherein the line adjustment graphic includes a line differential wheel that includes a plurality of line adjustments as calculated by the machine learning algorithm executing within the processor.

3. The gaming device of claim 2, wherein the plurality of line adjustments includes one or more positive line adjustments and one or more negative line adjustments.

4. The gaming device of claim 1, wherein the odds adjustment graphic includes a odds wheel that includes a plurality of odds adjustments as calculated by the machine learning algorithm executing within the processor.

5. The gaming device of claim 4, wherein the plurality of odds adjustments includes one or more positive odds adjustments and one or more negative odds adjustments.

6. The gaming device of claim 1, wherein the wager data comprises a home/away indication and event time/date information.

7. The gaming device of claim 1, wherein the display device, the touch screen input, and the processor are included within a mobile device.

8. The gaming device of claim 1 further including a gaming terminal with a housing that encloses the display device, the touch screen input, and the processor.

9. A computer-implemented method for a casino/sports-betting gaming system with an odds booster game, the method comprising:
receiving, from a data storage device, wager data corresponding to a plurality of events, betting lines, and wagers;
generating a graphical user interface (GUI) on a display device that receives an input that corresponds to a wager, wherein the input comprises a first wager input and a second wager input corresponding to the wager data;
receiving, via the GUI, the first wager input that selects a wager team, a wager line, and a wager odds from the wager data;
after receiving the first wager input, receiving, via the GUI, the second wager input that selects a wagering amount;
after receiving the second wager input, receiving, via the GUI, an odds booster input that corresponds to an odds booster game for the wager team, the wager line, the wager odds, and the wagering amount, wherein the odds booster game changes the wager line and the wager odds, wherein the odds booster game includes a machine learning algorithm executing within a processor that includes one or more of a line adjustment graphic and an odds adjustment graphic;
generating the line adjustment graphic on the GUI, via the machine learning algorithm executing within the processor;
calculating and adjusting, via the machine learning algorithm executing within the processor, an adjusted wager line using the line adjustment graphic;
generating the odds adjustment graphic on the GUI, via the machine learning algorithm executing within the processor;
calculating and adjusting, via the machine learning algorithm executing within the processor, an adjusted wager odds using the odds adjustment graphic;
displaying, via the GUI, final wager data that includes the wager team, the adjusted wager line, the adjusted wager odds, and the wagering amount; and
sending, via a communication interface and to the data storage device, the final wager data corresponding to the wager team, the adjusted wager line, the adjusted wager odds, and the wagering amount.

10. The method of claim 9, wherein the line adjustment graphic includes a line differential wheel that includes a plurality of line adjustments as calculated by the machine learning algorithm executing within the processor.

11. The method of claim 10, wherein the plurality of line adjustments includes one or more positive line adjustments and one or more negative line adjustments.

12. The method of claim 9, wherein the odds adjustment graphic includes a odds wheel that includes a plurality of odds adjustments as calculated by the machine learning algorithm executing within the processor.

13. The method of claim 12, wherein the plurality of odds adjustments includes one or more positive odds adjustments and one or more negative odds adjustments.

14. The method of claim 9, wherein the wager data comprises a home/away indication and event time/date information.

15. The method of claim 9, wherein the display device and the processor are included within a mobile device.

16. The method of claim 9, wherein the display device and the processor are included a gaming terminal with a housing that encloses the display device and the processor.

17. A system for an odds booster game comprising:
a processor; and
a memory coupled to the processor, the memory comprising machine-readable instructions that, when executed by the processor, cause the processor to:
receive, from a data storage device, wager data corresponding to a plurality of events, betting lines, and wagers;
generate a graphical user interface (GUI) on a display device that receives an input that corresponds to a wager, wherein the input comprises a first wager input and a second wager input corresponding to the wager data;
receive, via the GUI, the first wager input that selects a wager team, a wager line, and a wager odds from the wager data;
after receiving the first wager input, receive, via the GUI, the second wager input that selects a wagering amount;
after receiving the second wager input, receive, via the GUI, an odds booster input that corresponds to an odds booster game for the wager team, the wager line, the wager odds, and the wagering amount, wherein the odds booster game changes the wager line and the wager odds, wherein the odds booster game includes a machine learning algorithm executing within the processor that includes one or more of a line adjustment graphic and an odds adjustment graphic;
generate, calculate, and adjust, via the machine learning algorithm executing within the processor, an adjusted wager line using a line adjustment graphic;
generate, calculate, and adjust, via the machine learning algorithm executing within the processor, an adjusted wager odds using an odds adjustment graphic;
display, via the GUI, final wager data that includes the wager team, the adjusted wager line, the adjusted wager odds, and the wagering amount; and
send, via a communication interface and to the data storage device, the final wager data corresponding to the wager team, the adjusted wager line, the adjusted wager odds, and the wagering amount.

18. The system of claim 16 further including a mobile device that includes the processor and the memory.

19. The system of claim 16 further including a gaming terminal with a housing that encloses the processor and the memory.

20. The system of claim 16, wherein the line adjustment graphic includes a line differential wheel that includes a plurality of line adjustments as calculated by the machine learning algorithm executing within the processor, and wherein the plurality of line adjustments includes one or more positive line adjustments and one or more negative line adjustments; and further wherein the odds adjustment graphic includes a odds wheel that includes a plurality of odds adjustments as calculated by the machine learning algorithm executing within the processor, and wherein the plurality of odds adjustments includes one or more positive odds adjustments and one or more negative odds adjustments.
